(19) United States
(12) Patent Application Publication
(10) Pub. No.: US 2011/0235632 A1
(43) Pub. Date: Sep. 29, 2011

(54) Method And Apparatus For Performing High-Quality Speech Communication Across Voice Over Internet Protocol (VoIP) Communications Networks

(75) Inventors: Doh-Suk Kim, Basking Ridge, NJ (US); Ahmed Tarraf, Bayonne, NJ (US)

(73) Assignee: Alcatel-Lucent USA Inc.

(21) Appl. No.: 12/748,985

(22) Filed: Mar. 29, 2010

(51) Int. Cl. H04L 12/66

(52) U.S. Cl. 370/352

(57) ABSTRACT

A communications terminal device and a method performed by a communications terminal device wherein packet data received from a Wireless Personal Area Network (WPAN) headset (such as, for example, a Bluetooth headset), which comprises an encoded audio signal, is directly convened by the terminal device to Internet Protocol (IP) packets which are transmitted across a Voice over Internet Protocol (VoIP) communications network, wherein speech encoding is not performed by the terminal device. Similarly, a communications terminal device and a method performed by a communications terminal device wherein IP packet data comprising an encoded audio signal is received from a VoIP communications network by the terminal device, and is directly converted by the terminal device to WPAN packets (such as, for example, Bluetooth protocol packets) which are transmitted to a WPAN headset (such as, for example, a Bluetooth headset), wherein speech decoding is not performed by the terminal device.

### FIELD OF THE INVENTION

The present invention relates generally to the field of Voice over Internet Protocol (VoIP) speech communications networks, and more particularly to a method and apparatus for performing high quality speech communication across such networks.

### BACKGROUND OF THE INVENTION

Voice (i.e., speech) quality over the telephone has been relatively static for decades, since conventional circuit-switched telephone networks have a fundamental bandwidth limitation of 3400 Hz (Hertz). As such, conventional Public Switched Telephone Network (PSTN) and mobile phone network communications are currently limited to the frequency range of 300 Hz to 3400 Hz. However, the recent migration of voice communication into VoIP (Voice over Internet Protocol) communications networks opened a new era of possibilities to voice quality improvement. In particular, packet-based speech delivery over Internet Protocol (IP) networks can boost voice quality by extending the audio frequency range of transmitted speech signals beyond the conventional audio bandwidth limitation of 3400 Hz (as imposed by circuit-switched networks). In mobile voice communications, for example, High Definition (HD) voice is about to be introduced. Specifically, HD (i.e., “wideband”) voice provides much better quality and clarity than does conventional (i.e., “narrowband”) voice by covering the frequency range of 50 Hz to 7000 Hz. In general, such HD voice will be enabled by wideband speech coders in handsets that encode the acoustic signal captured through the handset microphone with a higher quality speech coder than do conventional narrowband speech coders.

However, Wireless Personal Area Network (WPAN) wireless headsets, such as Bluetooth (BT) headsets, are now being widely used, particularly among mobile phone users, for hands-free communication. Specifically, when a BT headset is used, an acoustic speech signal is captured through the microphone in the headset; the resultant audio signal waveform is compressed by an audio encoder; and the encoded audio signal is then transmitted to the mobile handset using the well-defined BT protocol. In the handset, the received encoded audio signal (i.e., the BT signal) is then decompressed by an audio decoder (which corresponds to the audio encoder in the BT headset) to produce a waveform, and the resultant waveform is then compressed again by a speech encoder for transmission through the network. Similar processing is performed in the reverse direction from the network back to a loudspeaker in the BT headset, except that there is typically a jitter buffer placed in front of the speech decoder in the handset to absorb the impact of network jitter (i.e., varying transmission delays of packets through the network). But audio codecs (i.e., encoder/decoder pairs) generally cover the audio spectrum up to 20 kHz (kilo Hertz) at very high bit rates above 100 kbps (kilobits/second), whereas speech codecs typically cover only up to either 3.4 kHz (for conventional “narrowband” speech codecs, such as, for example, Enhanced Variable Rate Codecs [EVRC] and Adaptive Multi-Rate [AMR] codecs), or 7 kHz (for more recently available “wideband” [WB or HD] codecs, such as, for example, AMR-WB), and typically operate at very low bit rates of approximately 10 kbps.

For the above reasons, there are several limitations encountered when using conventional (fixed or mobile) handsets with BT headsets. First, the audio bandwidth in current network environments is restricted by the limitations of the speech codec, despite the fact that a much higher quality audio codec is employed by the BT headset and that VoIP networks are capable of handling higher quality audio. For example, general audio signals (such as background sound or music) are handled quite poorly by speech codecs, since speech codecs are specifically designed for speech signals. And second, there is excessive latency (i.e., delay) in the processing path due to the fact that two coding processes—an audio codec and a speech codec—must be performed, with the more significant contribution to the total latency coming from the speech codec.

### SUMMARY OF THE INVENTION

The instant inventors have recognized that higher quality and lower latency speech communication may be advantageously provided over a VoIP communications network when Wireless. Personal. Area Network (WPAN) headsets (such as, for example, BT headsets) are being used. In particular, by taking advantage of the fact that such WPAN headsets typically include high quality audio codecs, the inventors have recognized that the speech encoding and decoding conventionally performed by mobile or wired handsets may be advantageously bypassed. As a result, higher quality and lower latency speech communication may be advantageously performed across VoIP communications networks.

Specifically, in accordance with certain illustrative embodiments of the present invention, encoded audio signal packets which have been transmitted to a terminal device (e.g. a handset) by a BT headset (using the BT protocol) may advantageously be directly converted into Internet Protocol (IP) packets—such as, for example, Real-time Transport Protocol (RTP) packets—by the terminal device, and then, these IP (e.g., RTP) packets, may be advantageously transmitted directly (i.e., without performing speech encoding) by the terminal device across the VoIP communications network. Similarly, in accordance with certain illustrative embodiments of the present invention, such IP (e.g., RTP) packets received at another (i.e., a recipient) terminal device (e.g., a handset) may be advantageously and correspondingly converted directly (i.e., without performing speech decoding) back to BT protocol packets for transmission by the recipient terminal device to another BT headset.

More specifically, in accordance with various illustrative embodiments of the present invention, a terminal device and a method performed by a terminal device are provided wherein packet data received from a BT headset which comprises an encoded audio signal is directly converted by the terminal device to RTP packets which are transmitted across the VoIP communications network, and wherein speech encoding is not performed by the terminal device. Similarly, in accordance with various illustrative embodiments of the present invention, a terminal device and a method performed by a terminal device are provided wherein RTP packet data comprising an encoded audio signal is received from a VoIP communications network by the terminal device and is directly converted by the terminal device to BT protocol packets which are transmitted to a BT headset, and wherein speech decoding is not performed by the terminal device.

In accordance with one illustrative embodiment of the present invention, a method performed by a terminal device for communicating speech across a Voice over Internet Protocol (VoIP) communications network is provided, the method comprising receiving a sequence of encoded audio signal packets using a wireless receiver, the encoded audio signal packets comprising data representative of speech, the encoded audio signal packets received from a Wireless Personal Area Network (WPAN); directly converting the received sequence of encoded audio signal packets into a corresponding sequence of Internet Protocol (IP) packets, wherein said conversion from said sequence of encoded audio signal packets to said sequence of IP packets is performed without the use of a speech encoder; and transmitting the sequence of IP packets across the VoIP communications network

In accordance with another illustrative embodiment of the present invention, a method performed by a terminal device for receiving speech which has been transmitted across a Voice over Internet Protocol (VoIP) communications network is provided, the method comprising receiving a sequence of Internet Protocol (IP) packets from the VoIP communications network, the IP packets comprising data representative of speech; directly converting the received sequence of IP packets into a corresponding sequence of encoded audio signal packets, wherein said conversion from said sequence of IP packets to said sequence of encoded audio signal packets is performed without the use of a speech decoder, and transmitting the sequence of encoded audio signal packets across a Wireless Personal Area Network (WPAN) using a wireless transmitter.

And in accordance with yet another illustrative embodiment of the present invention, a terminal device for communicating speech across a Voice over Internet Protocol (VoIP) communications network is provided, the device comprising a wireless receiver which receives a sequence of encoded audio signal packets, the encoded audio signal packets comprising data representative of speech, the encoded audio signal packets received from a Wireless Personal Area Network (WPAN); a packet conversion module which directly converts the received sequence of encoded audio signal packets into a corresponding sequence of Internet Protocol (IP) packets, wherein said conversion from said sequence of encoded audio signal packets to said sequence of IP packets is performed without the use of a speech encoder; and a packet transmitter which transmits the sequence of IP packets across the VoIP communications network.

And in accordance with still another illustrative embodiment of the present invention, a terminal device for receiving speech which has been transmitted across a Voice over Internet Protocol (VoIP) communications network is provided, the terminal device comprising a packet receiver which receives a sequence of Internet Protocol (IP) packets from the VoIP communications network, the IP packets comprising data representative of speech; a packet conversion module which directly converts the received sequence of IP packets into a corresponding sequence of encoded audio signal packets, wherein said conversion from said sequence of IP packets to said sequence of encoded audio signal packets is performed without the use of a speech decoder; and a wireless transmitter which transmits the sequence of encoded audio signal packets across a Wireless Personal Area Network (WPAN).

### BRIEF DESCRIPTION OF THE DRAWINGS

FIG. 1 shows a VoIP communications network environment in which various illustrative embodiments of the present invention may be advantageously implemented.

FIG. 2 shows a block diagram of a prior art user environment for use in communicating across a VoIP communications network, the user environment comprising a Bluetooth headset and a handset adapted for use therewith.

FIG. 3 shows a block diagram of an illustrative user environment for use in communicating across a VoIP communications network, the illustrative user environment comprising a Bluetooth headset and a handset adapted for use therewith, the illustrative user environment providing for high quality speech communication in accordance with an illustrative embodiment of the present invention.

FIG. 4 shows a flowchart of a method for converting a sequence of Bluetooth Protocol packets to a corresponding sequence of Real-time Transport Protocol (RTP) packets in accordance with an illustrative embodiment of the present invention, along with a sample of the operation of the illustrative method shown therein.

FIG. 5 shows a flowchart of a method for convening a sequence of Real-time Transport Protocol (RTP) packets to a corresponding sequence of Bluetooth Protocol packets in accordance with an illustrative embodiment of the present invention, along with a sample of the operation of the illustrative method shown therein.

### DETAILED DESCRIPTION OF THE PREFERRED EMBODIMENTS

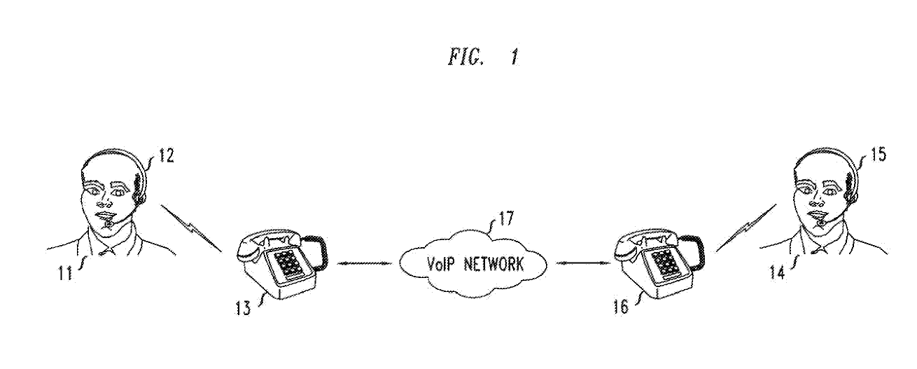

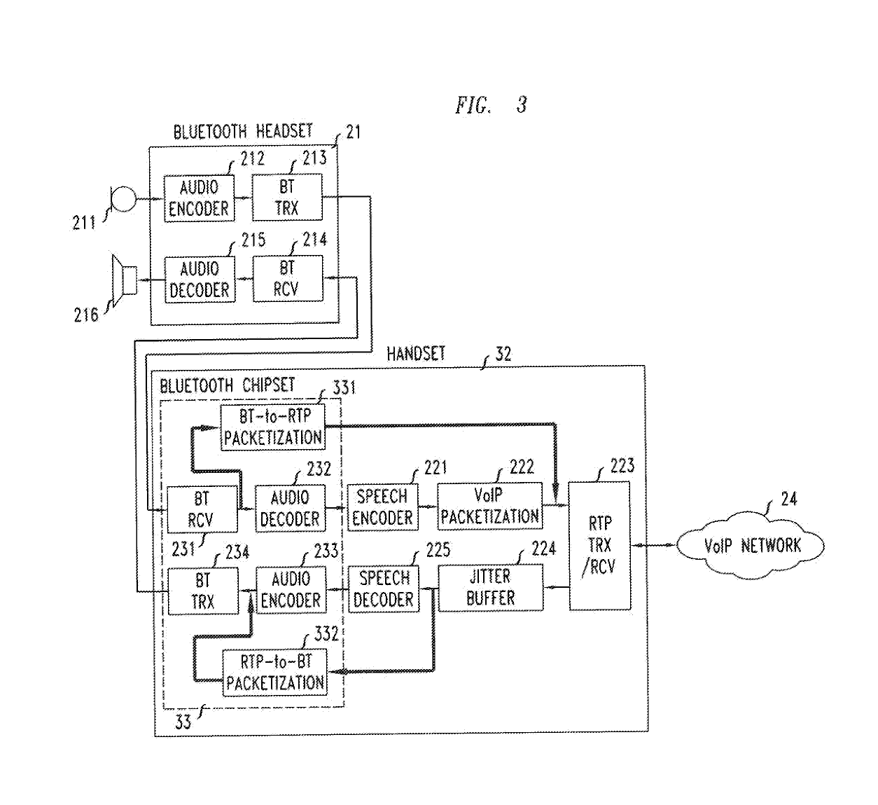

FIG. 1 shows a VoIP communications network environment in which various illustrative embodiments of the present invention may be advantageously implemented. As shown in the figure, user 11 is wearing Bluetooth headset 12 for performing Wireless Personal Area Network (WPAN) communication with handset 13. Similarly, user 14 is wearing Bluetooth headset 15 for performing Wireless Personal Area Network (WPAN) communication with handset 16. Handset 13 and handset 16, each of which may, for example, be either a wired handset or a mobile handset, are communicating with each other across VoIP network 17, enabling a conversation between user 11 (using Bluetooth headset 12) and user 14 (using Bluetooth headset 15). In accordance with various illustrative embodiments of the present invention, handset 13 and handset 16 may be advantageously implemented in accordance with the principles shown in FIG. 3. (See below.)

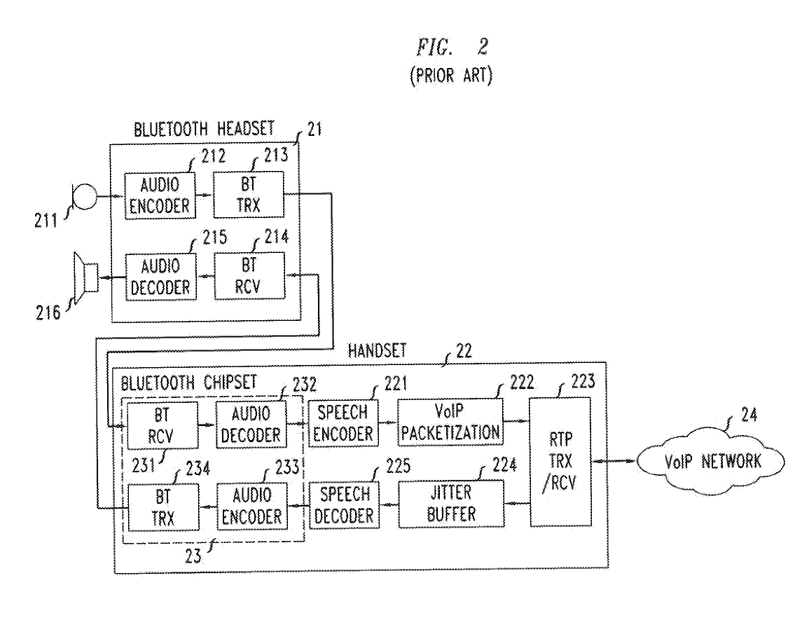

FIG. 2 shows a block diagram of a prior art user environment for use in communicating across a VoIP communications network, the user environment comprising a Bluetooth headset and a handset adapted for use therewith. The user environment includes Bluetooth (BT) headset 21, wirelessly connected (shown as direct arrowed connections for ease of understanding signal flow) to handset 22, which is in turn connected to VoIP network 24. In particular, to support the use of BT headset 21, handset 22 includes therein Bluetooth (BT) chipset 23. Note that handset 22 may be either a mobile handset (in which case VoIP network 24 comprises, at least in part, a wireless IP network, and wherein handset 22 is wirelessly connected thereto) or a wired handset (in which case VoIP network 24 comprises, at least in part, a wired IP network, and wherein handset 22 is connected thereto via a wired connection).

BT headset 21 comprises microphone 211, audio encoder 212, BT transmitter 213, BT receiver 214, audio decoder 215, and loudspeaker 216. Handset 22 comprises, in addition to BT chipset 23, speech encoder 221, VoIP packetization module 222, RTP transmitter and receiver 223, jitter buffer 224, and speech decoder 225. BT chipset 23 in turn comprises BT receiver 231, audio decoder 232, audio encoder 233, and BT transmitter 234.

In operation in the “forward” direction when BT headset 21 is being used (i.e., for transmitting speech across the VoIP network when the BT headset user is speaking), instead of capturing audio (e.g., speech) directly with use of handset 22's own microphone (not shown in the figure), an acoustic signal is captured through microphone 211 in the BT headset, producing an audio waveform. The audio waveform is then compressed by audio encoder 212 and wirelessly transmitted by BT transmitter 213 to handset 22 using a BT protocol. In handset 22, BT receiver 231 wirelessly receives this BT signal (which comprises encoded audio signal packets) and then audio decoder 232 decompresses the signal back into an audio waveform. Then, speech encoder 221 compresses this audio waveform (again), and VoIP packetization module 222 converts the encoded speech signal into IP packets—typically in Real-time Transport Protocol (RTP) form—to be transmitted by RTP transmitter and receiver 223 across VoIP network 24.

Similarly, in operation in the “reverse” direction (i.e., for receiving speech from the VoIP network when the BT headset user is listening), RTP transmitter and receiver 223 receives IP packets—typically in Real-time Transport Protocol (RTP) form—which it stores in jitter buffer 224. (As is well known to those of ordinary skill in the art, a jitter buffer is used to absorb the impact of network jitter—i.e., varying transmission delays of packets through the network.) Then, the stored packet data is read out of jitter buffer 224 and decompressed by speech decoder 225, producing an audio waveform. When BT headset 21 is being used, rather than handset 22 playing the audio waveform through its own loudspeaker (not shown in the figure), audio encoder 233 (re-)compresses the audio waveform and BT transmitter 234 wirelessly transmits this signal to BT headset 21 using a BT protocol. In BT headset 21, BT receiver 214 wirelessly receives this BT signal and audio decoder 215 decompresses the signal back into an audio waveform for playout by loudspeaker 216.

FIG. 3 shows a block diagram of an illustrative user environment for use in communicating across a VoIP communications network, the illustrative user environment comprising a Bluetooth headset and a handset adapted for use therewith, the illustrative user environment providing for high quality speech communication in accordance with an illustrative embodiment of the present invention. The illustrative user environment is similar to the prior art user environment shown in FIG. 2, but includes illustrative handset 32, which is similar to prior art handset 22 of FIG. 2 but has been modified in accordance with this illustrative embodiment of the present invention.

Specifically, the illustrative user environment of FIG. 3 includes Bluetooth (BT) headset 21, wirelessly connected (shown as direct arrowed connections for ease of understanding signal flow) to illustrative handset 32, which is in turn connected to VoIP network 24. In particular, illustrative handset 32 includes therein Bluetooth (BT) chipset 33 to support the use of BT headset 21. Specifically, note that BT chipset 33, in addition to comprising BT receiver 231, audio decoder 232, audio encoder 233, and BT transmitter 234 (as does prior art BT chipset 23), advantageously also comprises BT-to-RTP packetization module 331 and RTP-to-BT packetization module 332 for use in performing high quality speech communication across the VoIP communications network in accordance with this illustrative embodiment of the present invention. Note that illustrative handset 32 (like prior art handset 22) may be either a mobile handset (in which case VoIP network 24 comprises, at least in part, a wireless IP network, and wherein handset 32 is wirelessly connected thereto) or a wired handset (in which case VoIP network 24 comprises, at least in part, a wired IP network, and wherein handset 32 is connected thereto via a wired connection).

As in the prior art user environment shown in FIG. 2, BT headset 21 of the illustrative user environment of FIG. 3 comprises microphone 211, audio encoder 212, BT transmitter 213, BT receiver 214, audio decoder 215, and loudspeaker 216. However, unlike prior art handset 22, illustrative handset 32 comprises speech encoder 221, VoIP packetization module 222, RTP transmitter and receiver 223, jitter buffer 224, and speech decoder 225 (as does prior art handset 22), but also includes BT chipset 33 rather than BT chipset 23. Specifically, BT chipset 33, a modified version of prior art BT chipset 23, comprises BT receiver 231, audio decoder 232, audio encoder 233, and BT transmitter 234 (as does prior art BT chipset 22), but also advantageously includes BT-to-RTP packetization module 331 and RTP-to-BT packetization module 341.

In operation in the “forward” direction when BT headset 21 is being used (i.e., for transmitting speech across the VoIP network when the BT headset user is speaking), illustrative handset 32 may operate in a conventional manner, wherein BT receiver 231 wirelessly receives the BT signal, audio decoder 232 decompresses the signal back into an audio waveform, speech encoder 221 (re-)compresses this audio waveform, and VoIP packetization module 222 converts the encoded speech signal into IP packets, as does prior art handset 22 (as described in connection with the prior art user environment of FIG. 2 above). However, in accordance with the principles of the present invention and in accordance with an illustrative embodiment thereof, a “premium” mode of operation is available to illustrative handset 32 whereby high quality speech communication may be advantageously performed therein.

Specifically, when BT headset 21 is being used in the “forward” direction (i.e., for transmitting speech across the VoIP network when the BT headset user is speaking), illustrative handset 32 may operate in such a “premium” mode (as shown by the heavy arrows in FIG. 3) by advantageously bypassing audio decoder 232, speech encoder 221, and VoIP packetization module 222, and instead employing BT-to-RTP packetization module 331 to advantageously convert the received BT signal (which comprises encoded audio signal packets), as received by BT receiver 231, directly to RTP packets (which also comprise the encoded audio signal, albeit in a different format—i.e., in RTP format rather than in BT Protocol format) for transmission across VoIP network 24. In this manner, high quality speech signals are advantageously transmitted across the VoIP network for use by another illustrative handset capable of performing such “premium” mode speech communication.

Similarly, in operation in the “reverse” direction (i.e., for receiving speech from the VoIP network when the BT headset user is listening), illustrative handset 32 may operate in a conventional manner, wherein RTP transmitter and receiver 223 receives IP packets—typically in Real-time Transport Protocol (RTP) form—which it stores and then reads out of jitter buffer 224, decompresses with speech decoder 225 to produce an audio waveform, and then (re-)compresses with audio encoder 233 for wireless transmission by BT transmitter 234 to BT headset 21 using a BT protocol, as does prior art handset 22 (as described in connection with the prior art user environment of FIG. 2 above). However, in accordance with the principles of the present invention and in accordance with an illustrative embodiment thereof, a “premium” mode of operation is available to illustrative handset 32 whereby high quality speech communication may be advantageously performed therein.

Specifically, when BT headset 21 is being used in the “reverse” direction (i.e., for receiving speech from the VoIP network when the BT headset user is listening), illustrative handset 32 may operate in such a “premium” mode (as shown by the heavy arrows in FIG. 3) by advantageously bypassing speech decoder 225 and audio encoder 233, and instead employing RTP-to-BT packetization module 332 to advantageously convert the received RTP packets (which comprise encoded audio signal packets, assuming that they have been transmitted across VoIP network 24 by another such illustrative handset operating in “premium” mode), as received from VoIP network 24 (after having been stored and read out from jitter buffer 224), directly to BT packets (which also comprise the encoded audio signal, albeit in a different format—i.e., in BT Protocol format rather than in RTP format) for transmission to BT headset 21. In this manner, high quality audio may be received from another illustrative handset capable of performing such “premium” mode speech communication, and may be advantageously used by illustrative handset 32 and BT headset 21 of the illustrative user environment of FIG. 3.

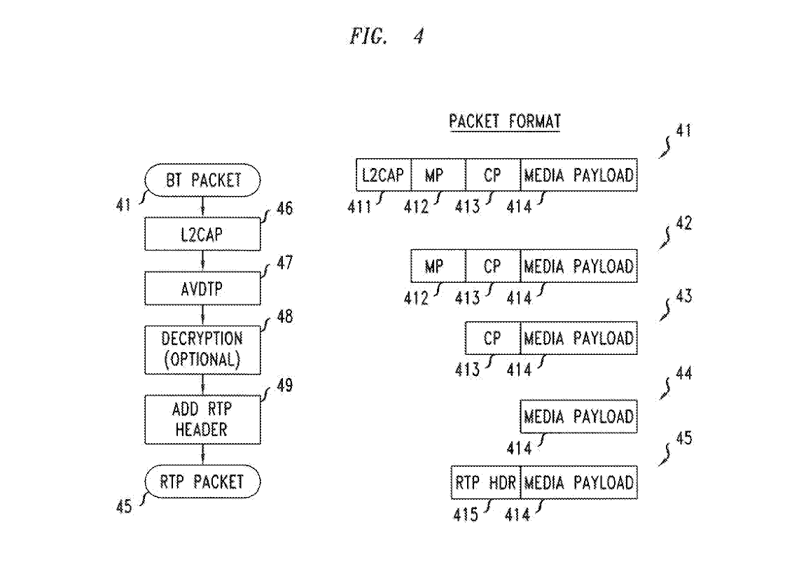

FIG. 4 shows a flowchart of a method for converting a sequence of Bluetooth Protocol packets to a corresponding sequence of Real-time Transport Protocol (RTP) packets in accordance with an illustrative embodiment of the present invention, along with a sample of the operation of the illustrative method shown therein. In particular, the illustrative method of FIG. 4 may, for example, be performed by BT-to-RTP packetization module 331 of illustrative handset 32 as shown in the illustrative user environment of FIG. 3.

As shown in the figure, illustrative BT Protocol packet 41 comprises Logical Link Control and Adaptation Protocol (L2CAP) header 411, followed by Media Packet (MP) header 412, followed by Contents Protection (CP) header 413, and then followed by media payload 414. (As is fully familiar to those of ordinary skill in the art, L2CAP is part of the BT Protocol. Each of the aforementioned headers is also fully familiar to those of ordinary skill in the art.) As is fully familiar to those of ordinary skill in the art, MP header 412 and CP header 413 together comprise the Audio/Visual Data Transport Protocol (AVDTP) header of the BT Protocol packet. And in accordance with the illustrative embodiment of the present invention, media payload 414 advantageously comprises a portion of an encoded audio signal which comprises speech, as illustratively provided, for example, by BT headset 21 of FIG. 3.

In step 46 of the illustrative method, L2CAP header 411 is removed from BT packet 41 to generate modified packet 42 (comprising only MP header 412, CP header 413 and media payload 414). Then, in step 47 of the illustrative method, the AVDTP header (MP header 412 and CP header 413 together) is removed from modified packet 42—first to generate modified packet 43 (comprising only CP header 413 and media payload 414), and then to generate therefrom modified packet 44 (comprising only media payload 414). Next, an optional step 48 may or may not be performed in which media payload 414 of modified packet 44 is decrypted. (This step is only performed in the case where media payload 414 has been encrypted prior to its receipt by the illustrative method of FIG. 4. As is well known to those skilled in the art, the BT Protocol provides for optional secure communication using conventional encryption techniques.) And finally, in step 49 of the illustrative method, RTP header 415 is added to modified packet 44 to generate RTP packet 45 for transmission across the VoIP network. The illustrative method advantageously repeats for a given sequence of BT Protocol packets input thereto.

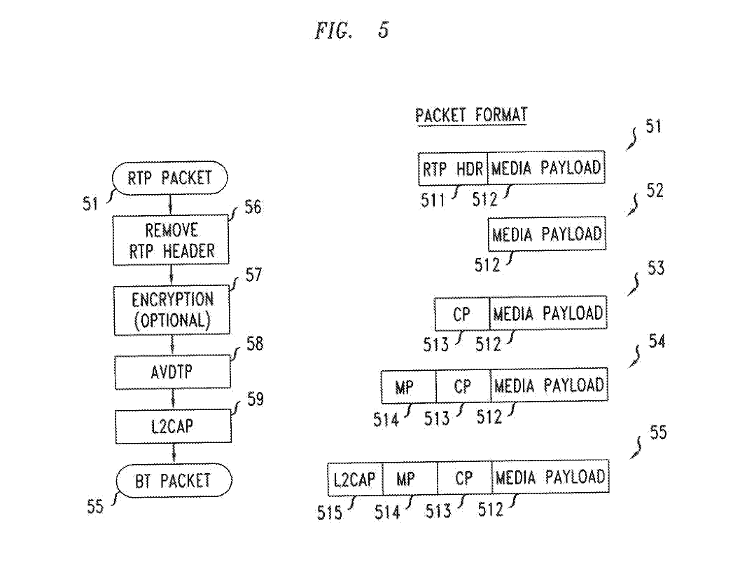

FIG. 5 shows a flowchart of a method for converting a sequence of Real-time Transport Protocol (RTP) packets to a corresponding sequence of Bluetooth Protocol packets in accordance with an illustrative embodiment of the present invention, along with a sample of the operation of the illustrative method shown therein. In particular, the illustrative method of FIG. 5 may, for example, be performed by RTP-to-BT packetization module 332 of illustrative handset 32 as shown in the illustrative user environment of FIG. 3.

As shown in the figure, illustrative RTP packet 51 comprises RTP header 511 followed by media payload 512. In accordance with the illustrative embodiment of the present invention, media payload 512 advantageously comprises a portion of an encoded audio signal which comprises speech, as illustratively received from, for example, VoIP network 24 of FIG. 3.

In step 56 of the illustrative method, RTP header 511 is removed from RTP packet 51 to generate modified packet 52 (comprising only media payload 512). Next, an optional step 57 may or may not be performed in which media payload 512 of modified packet 52 is encrypted (for purposes of optional secure BT communication—see discussion above). Then, in step 58 of the illustrative method, the AVDTP header (comprising CP header 513 preceded by MP header 514) is added to modified packet 52—first to generate modified packet 53 (comprising CP header 513 and media payload 512), and then to generate therefrom modified packet 54 (comprising MP header 514, CP header 513 and media payload 512). Finally, in step 59 of the illustrative method, L2CAP header 515 is added to modified packet 54 to generate BT packet 55 for use in transmission to, for example, BT headset 21 of FIG. 3. The illustrative method advantageously repeats for a given, sequence of RTP packets input thereto.

Finally, note that in accordance with certain illustrative embodiments of the present invention, a “premium” VoIP call may advantageously be initially set up between two parties (e.g., two illustrative handsets implemented in accordance with the principles of the present invention and in accordance with illustrative embodiments thereof), using a slightly modified version of an otherwise fully conventional technique. As is well known to those of ordinary skill in the art, typical VoIP calls have such an “initial” call setup phase in which the characteristics of the speech data to be communicated between the parties to the call is communicated and/or negotiated with and between the network and the intended parties to the call. For example, the specific codec type typically needs to be communicated/negotiated, since only if both parties' handsets support a particular coding scheme (e.g., EVRC, AMR, etc.) will it be possible for them to communicate using that scheme.

Therefore, in accordance with certain illustrative embodiments of the present invention, at the beginning of a VoIP call which is desired to be performed in a “premium” mode of operation (using the principles of the present invention), the handsets advantageously communicate with the network and each other in order to negotiate such a resource—namely, to ensure that both parties can support such “premium” calls using a common encoding format. For example, if both parties' handsets are being used specifically with BT headsets which use a common audio codec, then they may communicate in accordance with the illustrative embodiment shown and described above in connection with FIG. 3. In particular, then, after checking the connectivity to the given BT headset, the specific audio codec information associated with the BT headset may be advantageously included in a network signaling message (i.e., communicated as part of the call setup phase), whenever an initial call request is made in accordance with an illustrative embodiment of the present invention. Then, assuming compatibility, the network advantageously sends confirmatory messages to both handsets to enable the “premium” call mode.

### Addendum to the Detailed Description

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

A person of ordinary skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

The functions of any elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A method performed by a terminal device for communicating speech across a Voice over Internet Protocol (VoIP) communications network, the method comprising:
receiving a sequence of encoded audio signal packets using a wireless receiver, the encoded audio signal packets comprising data representative of speech, the encoded audio signal packets received from a Wireless Personal Area Network (WPAN);
directly converting the received sequence of encoded audio signal packets into a corresponding sequence of Internet Protocol (IP) packets, wherein said conversion from said sequence of encoded audio signal packets to said sequence of IP packets is performed without the use of a speech encoder; and
transmitting the sequence of IP packets across the VoIP communications network

2. The method of claim 1 wherein the WPAN is implemented using a Bluetooth (BT) protocol and wherein the encoded audio signal packets have been transmitted across said WPAN in conformance therewith.

3. The method of claim 1 wherein the IP packets comprise Real-time Transport Protocol (RTP) packets.

4. The method of claim 1 wherein the conversion from said sequence of encoded audio signal packets to said sequence of IP packets is also performed without the use of an audio decoder.

5. The method of claim 1 wherein the terminal device comprises a mobile handset, and wherein the VoIP communications network comprises an IP based wireless communications network.

6. The method of claim 1 further comprising performing a VoIP call setup exchange across the VoIP communications network with another terminal device, wherein the VoIP call setup exchange comprises identifying to the other terminal device that the encoded audio signal is to be communicated to said other terminal device without first performing speech encoding thereupon.

7. A method performed by a terminal device for receiving speech which has been transmitted across a Voice over Internet Protocol (VoIP) communications network, the method comprising:
receiving a sequence of Internet Protocol (IP) packets from the VoIP communications network, the IP packets comprising data representative of speech;
directly converting the received sequence of IP packets into a corresponding sequence of encoded audio signal packets, wherein said conversion from said sequence of IP packets to said sequence of encoded audio signal packets is performed without the use of a speech decoder; and
transmitting the sequence of encoded audio signal packets across a Wireless Personal Area Network (WPAN) using a wireless transmitter.

8. The method of claim 7 wherein the WPAN is implemented using a Bluetooth protocol and wherein the encoded audio signal packets are transmitted across said WPAN in conformance therewith.

9. The method of claim 7 wherein the IP packets comprise Real-time Transport Protocol (RTP) packets.

10. The method of claim 7 wherein the conversion from said sequence of IP packets to said sequence of encoded audio signal packets is also performed without the use of an audio encoder.

11. The method of claim 7 wherein the terminal device comprises a mobile handset, and wherein the VoIP communications network comprises an Internet Protocol (IP) based wireless communications network.

12. The method of claim 7 further comprising performing a VoIP call setup exchange across the VoIP communications network with another terminal device, wherein the VoIP call setup exchange comprises identifying to the other terminal device that the encoded audio signal is to be communicated by said other terminal device without first performing speech encoding.

13. The method of claim 7 wherein the IP packets are stored in a jitter buffer upon receipt from the VoIP communications network and are read out of said jitter buffer for said conversion to said sequence of encoded audio signal packets.

14. A terminal device for communicating speech across a Voice over Internet Protocol (VoIP) communications network, the device comprising:
a wireless receiver which receives a sequence of encoded audio signal packets, the encoded audio signal packets comprising data representative of speech, the encoded audio signal packets received from a Wireless Personal Area Network (WPAN);
a packet conversion module which directly converts the received sequence of encoded audio signal packets into a corresponding sequence of Internet Protocol (IP) packets, wherein said conversion from said sequence of encoded audio signal packets to said sequence of IP packets is performed without the use of a speech encoder; and
a packet transmitter which transmits the sequence of IP packets across the VoIP communications network

15. The terminal device of claim 14 wherein the WPAN is implemented using a Bluetooth protocol and wherein the encoded audio signal packets have been transmitted across said WPAN in conformance therewith.

16. The terminal device of claim 14 wherein the IP packets comprise Real-time Transport Protocol (RTP) packets.

17. The terminal device of claim 14 wherein the conversion from said sequence of encoded audio signal packets to said sequence of IP packets is also performed without the use of an audio decoder.

18. The terminal device of claim 14 wherein the terminal device comprises a mobile handset, and wherein the VoIP communications network comprises an Internet Protocol (IP) based wireless communications network.

19. The terminal device of claim 14 further comprising performing a VoIP call setup exchange module which communicates across the VoIP communications network with another terminal device, wherein the VoIP call setup exchange module identifies to the other terminal device that the encoded audio signal is to be communicated to said other terminal device without first performing speech encoding thereupon.

20. A terminal device for receiving speech which has been transmitted across a Voice over Internet Protocol (VoIP) communications network, the terminal device comprising:
a packet receiver which receives a sequence of Internet Protocol (IP) packets from the VoIP communications network, the IP packets comprising data representative of speech;
a packet conversion module which directly converts the received sequence of IP packets into a corresponding sequence of encoded audio signal packets, wherein said conversion from said sequence of IP packets to said sequence of encoded audio signal packets is performed without the use of a speech decoder; and
a wireless transmitter which transmits the sequence of encoded audio signal packets across a Wireless Personal Area Network (WPAN).

21. The terminal device of claim 20 wherein the WPAN is implemented using a Bluetooth protocol and wherein the encoded audio signal packets are transmitted across said WPAN in conformance therewith.

22. The terminal device of claim 20 wherein the IP packets comprise Real-time Transport Protocol (RTP) packets.

23. The terminal device of claim 20 wherein the conversion from said sequence of IP packets to said sequence of encoded audio signal packets is also performed without the use of an audio encoder.

24. The terminal device of claim 20 wherein the terminal device comprises a mobile handset, and wherein the VoIP communications network comprises an Internet Protocol (IP) based wireless communications network.

25. The terminal device of claim 20 further comprising performing a VoIP call setup exchange module which communicates across the VoIP communications network with another terminal device, wherein the VoIP call setup exchange module identifies to the other terminal device that the encoded audio signal is to be communicated by said other terminal device without first performing speech encoding.

26. The terminal device of claim 20 further comprising a jitter buffer which stores the IP packets upon receipt from the VoIP communications network and from which the IP packets are read out for said conversion to said sequence of encoded audio signal packets.
